(19) United States
(12) Patent Application Publication
(10) Pub. No.: US 2005/0018368 A1
(43) Pub. Date: Jan. 27, 2005

(54) DC reactor with bobbin equipped with supplementary winding

(75) Inventors: Tae Kuk Ko, Seoul (KR); Seung Je Lee, Seoul (KR); Min Cheol Ahn, Gyounggi-Do (KR); Duck Kwon Bae, Seoul (KR); Hyoung Ku Kang, Gyounggi-Do (KR)

Correspondence Address: CONNOLLY BOVE LODGE & HUTZ LLP, SUITE 800, 1990 M STREET NW, WASHINGTON, DC, 20036-3425, US

(73) Assignee: Yonsei University, Seoul (KR)

(21) Appl. No.: 10/868,893

(22) Filed: Jun. 17, 2004

(30) Foreign Application Priority Data
Jun. 17, 2003 (KR) 10-2003-39074

(51) Int. Cl. H02H 7/00

(52) U.S. Cl. 361/19

(57) ABSTRACT

A design of a bobbin for stacking a superconducting coil used in a DC reactor of a current limiting device for limiting fault current of an electric power system, is provided. The design of the bobbin overcomes difficulties of windings and problems including insulation between coils, difficulty in design of shape of bobbin, increase of joints, and degradation of stability caused during transposing of stacked windings of the superconducting coil. A superconducting coil is not quenched at a normal state, but the superconducting coil is quenched upon occurrence of fault current. When such is a case, current generally flows along the lowest resistance path, and the portion of the superconducting coil is overheated. The bobbin is equipped with a supplementary winding of conducting coil at the outer portion of the bobbin such that the supplementary winding of conducing coil bears the current of early stage of fault current and the volume of current flowing to the superconducting coil is decreased when the current is higher than the threshold current, thereby protecting the superconducting coil.

### BACKGROUND OF THE INVENTION

1. Field of the Invention

The present invention relates to a design of a bobbin for stacking a superconducting coil used in a DC reactor of a current limiting device for limiting fault current of an electric power system, and more particularly, to a design of a bobbin equipped with a supplementary winding for overcoming difficulties of windings and problems including insulation between coils, difficulty in design of shape of bobbin, increase of joints, and degradation of stability during transposing of stacked windings of a superconducting coil, so as to prevent the superconducting coil from being overheated upon occurrence of fault current.

A conducting coil allows for flow of a current without causing losses of current since the conducting coil scarcely has impedances. However, conducting coil has drawbacks in that quench occurs so as to cause a difference of resistances between the conducting coils when the current flowing along the coil is larger than the threshold current. Moreover, large volume of current flows along the inside of the coil along the minimum energy path according to Lagrange Principle, thereby generating increased volume of heat. To permit all windings of conducting coil to bear fault current in a uniform manner, it is required that the windings have the same length. For this purpose, the stacked windings are transposed. However, such a transposition has drawbacks in that stability is degraded at the normal state where fault current is not generated. Moreover, winding manner is difficult in transposing and insulation between windings is required. In addition, count of joints increases by four times, and difficulty still exists in designing of shape of bobbin such that the transposing is easily carried out.

Japanese Patent No. JP5226142 discloses a method of applying a special material to the gap formed between layers of superconducting coil so as to maintain a superior electrical insulating property. Japanese Patent No. JP5326249 discloses a method of suppressing quench by performing an accurate winding of superconducting coil. However, these two methods still require insulation between windings and winding manner is not easy. Japanese Patent No. JP63192208 discloses a method for avoiding concentration of coil energy and preventing burning of the coil contacting a bobbin. The method disclosed in the Japanese Patent No. JP63192208 is characterized in that a thin film made up of an inorganic insulator having an excellent thermal conductivity is coated so as to prevent a concentration of energy and burning of coil upon occurrence of quenching in a certain part of coil. However, the method of JP63192208 still has problems in efficiency and complicated work procedures.

### SUMMARY OF THE INVENTION

Therefore, it is an object of the present invention to provide a DC reactor having a bobbin equipped with a supplementary winding which eliminates the necessity of insulation between windings of a superconducting coil, and adopts a supplementary winding for preventing concentration of current on a certain part of the superconducting coil upon occurrence of fault current even without using a transposing method, and allowing for flow of current through the supplementary winding during an early stage of faults of system.

### DESCRIPTION OF THE DRAWINGS

FIG. 1 illustrates a simulation equivalent circuit in case where a superconducting coil is transposed;

FIG. 2 illustrates a simulation equivalent circuit in case where a superconducting coil is not transposed;

FIG. 3 is a graphical representation of current distribution of the circuit shown in FIG. 1;

FIG. 4 is a graphical representation of voltage distribution of the circuit shown in FIG. 1;

FIG. 5 is a graphical representation of current distribution in case where a superconducting coil is not transposed;

FIG. 6 is a graphical representation of voltage distribution in case where a superconducting coil is not transposed;

FIG. 7 is a graphical representation of initial current charging for conducting coil and superconducting coil in accordance with an embodiment of the present invention; and

FIG. 8 is a graphical representation of current flow for conducting coil and superconducting coil, illustrating the result of simulation upon occurrence of fault current.

### DETAILED DESCRIPTION OF THE PRESENT INVENTION

The present invention will be explained in more detail with reference to the attached drawings. In Figures, identical elements bear identical reference numerals and the detailed description on the related arts or configuration will be omitted for clarity of the present invention.

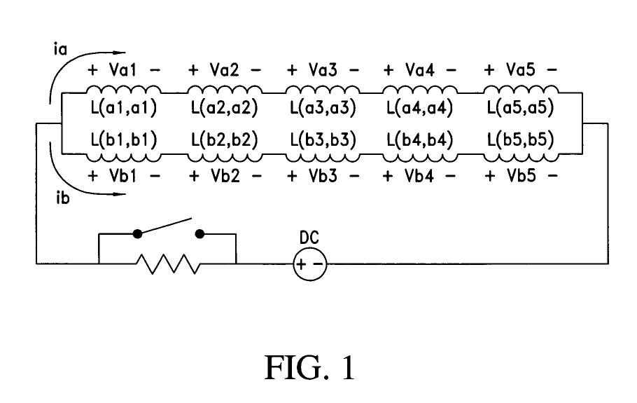

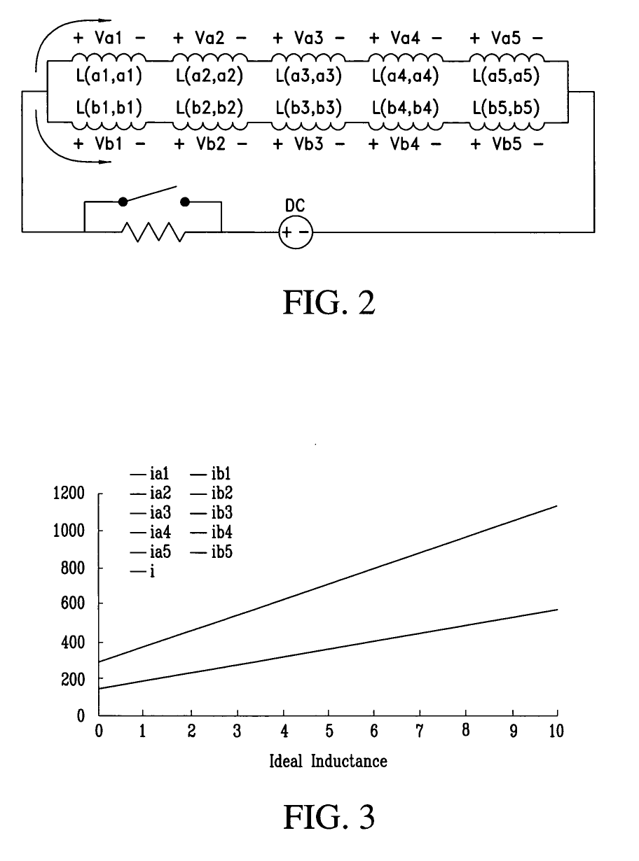

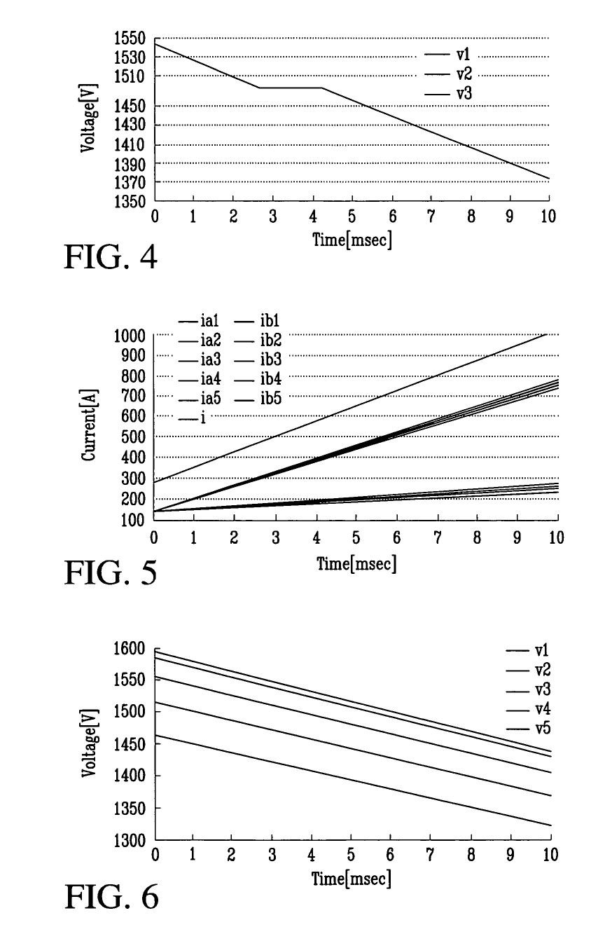

FIG. 1 and FIG. 2 respectively illustrate simulation equivalent circuits in cases where a superconducting coil is transposed and not transposed. Herein, a single bobbin is referred to as a single layer, and a single winding is referred to as a single stack. The simulation is performed by using two stacks and five layers so as to simplify a circuit configuration. Herein, DC voltage source is 8000V and load resistance is 1Ω. The current and voltage of the circuit of FIG. 1 are illustrated in FIGS. 3 and 4, respectively. The current and voltage of the circuit of FIG. 2 are illustrated in FIGS. 5 and 6, respectively. In case where the superconducting coil is transposed, two coil currents are generated but each stack has the same current. In cases where the superconducting coil is not transposed, ten coil currents are generated and each of stacks has different currents. As current increases, difference of current between layers becomes larger. Large volume of fault current flows along the inner stack, and the outer stack cannot bear the fault current, thereby causing overheat in the inner stack. That is, current can be distributed in a uniform manner in case where the superconducting coil is transposed, and large volume of current may be concentrated on a single side in case where the superconducting coil is not transposed.

Current flows along the minimum energy according to Lagrange Principle. Accordingly, large volume of current flows along the inside of the coil having a less impedance. Upon occurrence of fault current, the innermost superconducting coil is concentrated with the fault current, and the outer windings have relatively less current. In case where the current higher than the threshold current flow in the innermost superconducting coil, quenching occurs. This causes generation of large volume of heat, increasing the possibility of problems in cooling the innermost superconducting coil. Thus-generated heat causes differences of directions and thermal expansions of bobbin and superconducting coil, resulting in problems of contact between the bobbin and superconducting coil. This may bring about a severe quenching caused due to frictional heat generated from the motion of the superconducting coil, or problems of high pressure being applied to the bobbin due to the evaporation of liquid refrigerant. When these problems become serious, superconducting coil may be burnt.

Therefore, a need of transposing windings of coil arises. In case where windings of superconducting coil are transposed, fault current is uniformly distributed to each of windings of superconducting coil even upon occurrence of fault of system so as to thereby prevent a concentration of energy, since each of windings of superconducting coil has a uniform impedance. However, such a transposing method still has drawbacks in that insulation between windings is needed and transposed winding method is not easy.

A method of minimizing the current flowing along the superconducting coil, even without transposing the windings of the coil, may avoid problems and waste caused due to transposing. The present invention adopts a conducting supplementary winding of coil on the outermost part of the bobbin so as to prevent problems and waste caused due to transposing.

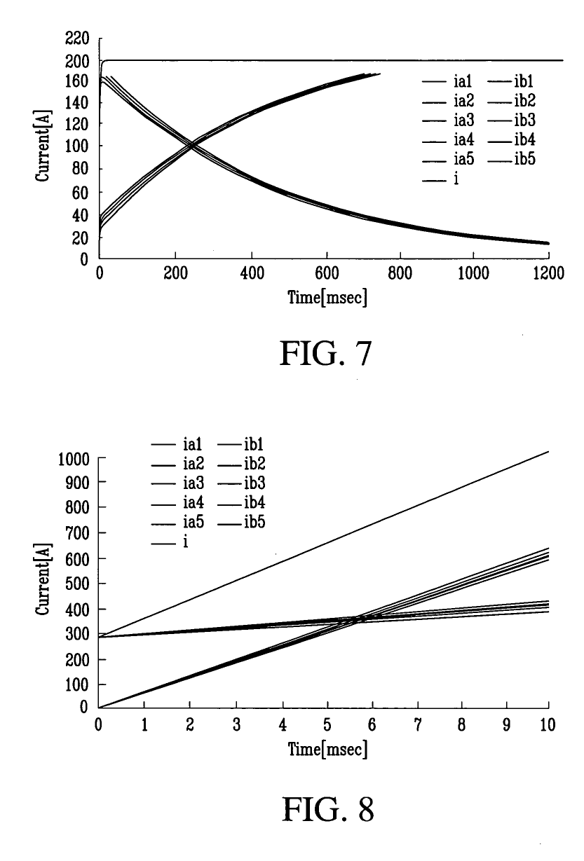

FIG. 7 illustrates an initial current charging in case where a bobbin adopts a conducting supplementary winding of coil. As shown in FIG. 7, the normal state does not show any change even when the supplementary winding is adopted. In the normal state, impedance of superconducting coil is nearly zero. Therefore, current may not flow to the conducting supplementary winding of coil having a relatively larger impedance. The uppermost line of the graphical representation of FIG. 7 shows the total current. In FIG. 7, the current being charged decreases in the conducting winding of coil, and almost all of the current flows to the superconducting coil at the normal state.

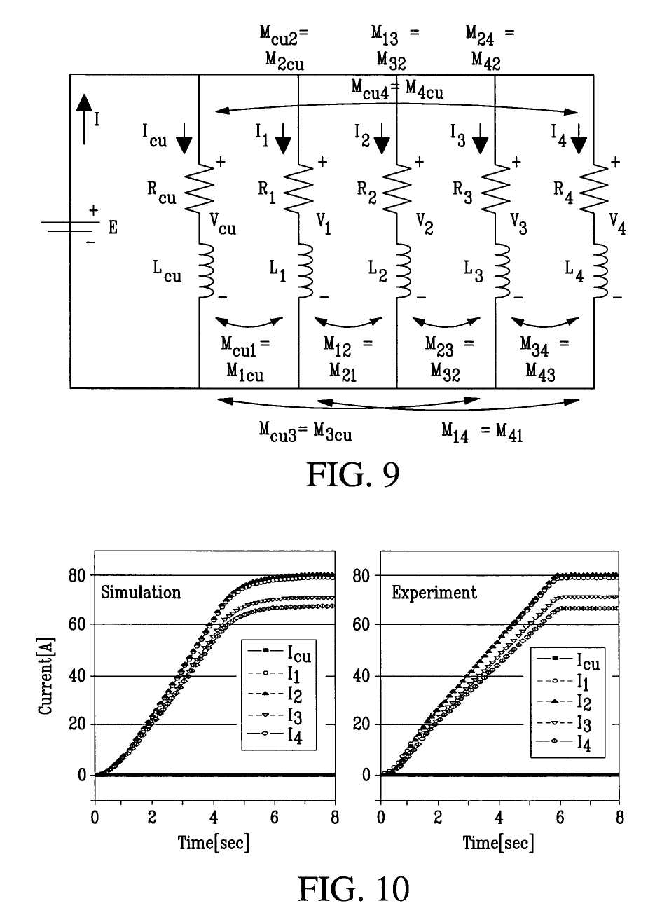

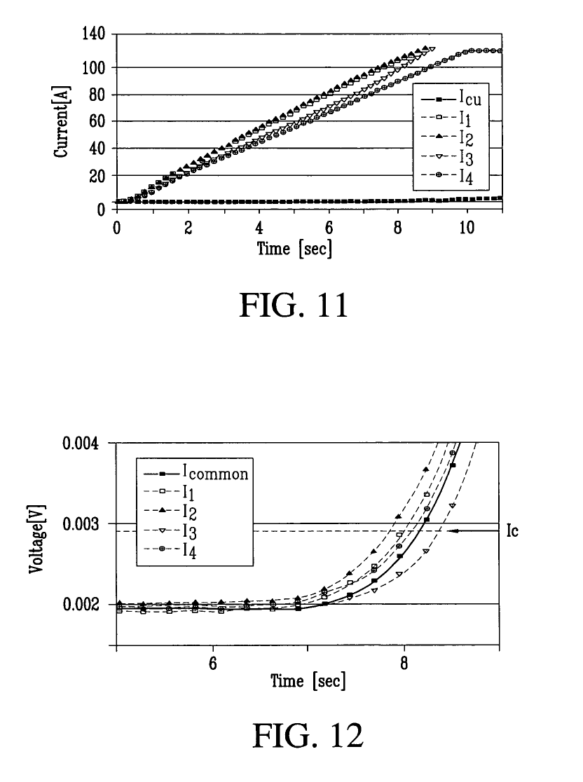

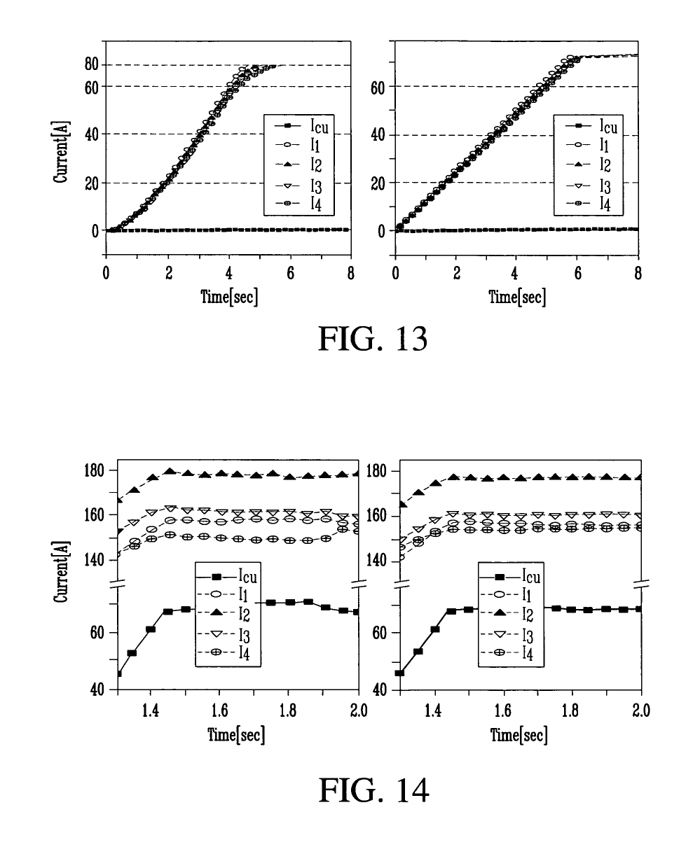

FIG. 8 illustrates current flowing along the superconducting coil and conducting coil upon occurrence of fault current. The uppermost line of the graphical representation shows the total current. The superconducting coil is quenched upon occurrence of fault current, resulting in a significantly high impedance of the superconducting coil. The supplementary conducting coil has a relatively low impedance, and current flows to the supplementary conducting coil, thereby accomplish a uniform current flow in the superconducting coil. The current of the superconducting coil is maintained at the level lower than the threshold and a thermal stability is obtained even when the superconducting coil is quenched, as along as the superconducting coil can bear the intial current of an early stage of fault (approximately 20 ms). In case where fault current occurs, the current flows to the supplementary winding of coil made up of a copper, thereby preventing a sudden flow of current toward the superconducting coil of the bobbin for a predetermined time period.

In case where a supplementary conducting coil is adopted, the supplementary conducting coil bears fault current even when the windings of the coil are stacked without being transposed. In this case, insulation between windings is not necessary. Even in case where the windings of the coil are transposed, use of a bobbin with a supplementary winding of coil achieves improved stability of product.

The supplementary conducting coil is made up of a material including a copper.

Insulation between windings of coil can be obtained from the supplementary conducting coil made up of a copper. At a normal state, impedance of the copper is significantly larger than the impedance of the superconducting coil, and becomes relatively smaller upon occurrence of fault current. Therefore the coil made up of the copper bears the fault current, to thereby prevent the current from being concentrated on the superconducting coil of the minimum path and accomplish insulation between windings of coil. That is, transposing method requires insulation between windings of coil upon occurrence of fault current. In the present invention, superconducting coil is prevented from an excessive current, thereby eliminating the necessity of insulation between windings of coil. However, it is preferable that a transposing is performed at joints.

In case of transposing windings of coil, conducting coil made up of a coil can be stacked together so as to allow for flexible conditions of transposing.

As an embodiment of the present invention, current sharing in two types of 5-stacked HTS(High Temperature Superconducting) solenoid coils, made up of 1 copper layer which is a current buffer layer of HTS coil and 4 HTS wire layers, is analyzed. Also, current sharing of a multi-stacked HTS solenoid coil is simulated using by finite element method (FEM) and finite difference method (FDM).

Two types of coils are fabricated. One is wound with Bi-2223 wire insulated with polyimide tape and the other is wound with non-insulated Bi-2223 wire. Table I shows the specification of small-scale HTS solenoid coils.

TABLE I

| | Specification | | Remarks |
|---|---|---|---|
| Number of stacked | 5 | ea | 1 Cu + 4 HTS wire |
| wires | | | |
| Thickness of wire | 0.8/0.3 | mm | Cu/HTS wire |
| Number of turns | 21 | turns | |
| Height | 129 | mm | |
| Inner diameter | 134 | mm | |
| Outer diameter | 138.8 | mm | |
| Winding pitch | 6.25 | mm | |
| Width of groove | 4 | mm | |
| Depth of groove | 3 | mm | |

The used HTS wire is “high strength wire” of American Superconductor®. Certified minimum critical current of this wire is 115 A (@77K, self field) and it is reinforced with stainless steel. Bobbins for winding are made of glass fiber reinforced plastic (GFRP). The groove, which is 4 mm width and 3 mm depth, is processed on these bobbins to stack several HTS wires. Firstly, copper with 0.8 mm thickness is wound in the groove, and then 4 layers of HTS wire are wound. Innermost HTS wire is named HTS₁ and current flowing this layer is named I₁. Outermost wire is named HTS₄. Each current, flowing a copper and 4 HTS wires, is measured with 3285 clamp on AC/DC HiTESTER of HIOKI Co. Resistance and critical current of each path and whole critical current are calculated with the measured current and voltage of 16 voltage taps mounted at each path of the coil. All signals through the low pass filters are recorded in a data acquisition system.

In order to simulate the current sharing characteristics in multi-strand HTS solenoid coil, an electric equivalent circuit of this coil is needed. FIG. 9 shows the equivalent circuit of the HTS solenoid coil, which has one path of copper and four paths of HTS wire. The electrical parameters in the circuit are defined as follows

R_{cu}, . . . R₄: Resistance of each path,

V_{cu}, . . . V₄: Voltage drop of each path,

L_{cu}, . . . L₄: Self-inductance of each path,

M_{ab}=M_{ba}: Mutual inductance between Lₐ and L_{b}.

First, self inductance of each stack and mutual inductance between stacks of multi-stacked HTS solenoid coil are calculated by Magneto-static analysis with FEM. Based on the distribution of the magnetic flux density of HTS coil, self and mutual inductance of this coil are calculated. Table II shows the calculated inductance.

TABLE II

| | Value | | Value | | Value |
|---|---|---|---|---|---|
| | μH | | μH | | μH |
| L_{cu} | 41.22 | M_{cu1} = M_{1cu} | 41.14 | M₁₃ = M₃₁ | 41.63 |
| L₁ | 42.00 | M_{cu2} = M_{2cu} | 40.92 | M₁₄ = M₄₁ | 41.22 |
| L₂ | 42.41 | M_{cu3} = M_{3cu} | 40.73 | M₂₃ = M₃₂ | 42.29 |
| L₃ | 42.83 | M_{cu4} = M_{4cu} | 40.56 | M₂₄ = M₄₂ | 42.04 |
| L₄ | 43.24 | M₁₂ = M₂₁ | 41.88 | M₃₄ = M₄₃ | 42.70 |

The voltages and currents in each path of the equivalent circuit, showing in FIG. 9, are governed by the following equation(1):

$$V = L \frac{ⅆ I}{ⅆ t} + RI \qquad ( 1 )$$

Applying FDM on the equation (1):

$$I [ k + 1 ] = {( R + \frac{L}{{⋀}_{t}} )}^{- 1} \times ( \frac{L}{{⋀}_{t}} \times I [ k ] + V ) \qquad ( 2 )$$

The matrices of the electric parameters used in equation (2) are shown below

$$I = [ \begin{matrix}{i}_{cu} \\ {i}_{1} \\ … \\ {i}_{4}\end{matrix} ] , V = [ \begin{matrix}{V}_{cu} \\ {V}_{1} \\ … \\ {V}_{4}\end{matrix} ] , L = [ \begin{matrix}{L}_{cu} & {M}_{cu1} & … & {M}_{cu4} \\ {M}_{1 cu} & {L}_{1} & … & {M}_{14} \\ … & … & … & … \\ {M}_{4 cu} & {M}_{41} & … & {L}_{4}\end{matrix} ] , R = [ \begin{matrix}Rcu & 0 & … & 0 \\ 0 & R1 & … & 0 \\ … & … & … & … \\ 0 & 0 & … & R4\end{matrix} ] \qquad ( 3 )$$

Table III shows the resistances of each path for FDM. They are all measured from fabricated small-scale HTS solenoid coils. As these coils contain a normal conducting part to settle current probes, several joint resistances and different resistances generated by the same transport current, each path of coils has different resistances.

TABLE III

| | R_{cu} | R₁ | R₂ | R₃ | R₄ |
|---|---|---|---|---|---|
| | mΩ | μΩ | μΩ | μΩ | μΩ |
| Coil with | 11.0 | 144 | 141 | 160 | 168 |
| insulate wire | | | | | |
| Coil with non- | 11.2 | 118 | 123 | 126 | 129 |
| insulate wire | | | | | |

FIG. 10 shows the simulated and measured current sharing result of insulated and multi-stacked HTS solenoid coil. Self and mutual inductance values for simulation are shown in Table II and resistance values are shown in Table III. Transport current is increased to 300 A with a ramping rate of 50 A/s. Simulated values of final current of I_{cu}, I₁, I₂, I₃ and I₄ are 0.32, 79.31, 80.65, 71.50, 67.96 A, respectively. Experimental results of the final current of each path are 0.003, 79.27, 80.60, 71.68, 67.12 A, respectively. These results show that simulation of current sharing is successfully implemented. Although the simulated result shows the effect of time constant of the coil in current increasing of each path, the experimental result is affected less than the simulated result because of the feed-back mechanism of the power supply used.

FIG. 11 shows the experimental current sharing result of the HTS coil with ramping a rate of 50 A/s and a final current of 500A. FIG. 12 shows the voltage of each voltage tap according to the time of current increase. Table IV shows the critical current of each path and whole coil. 1μ V/cm criterion is used to determine critical current.

TABLE IV

| | HTS₁ | HTS₂ | HTS₃ | HTS₄ | Whole |
|---|---|---|---|---|---|
| Critical current | 104.0 A | 103.5 A | 103.9 A | 90.7 A | 399 A |
| Exceed time | 7.92 s | 7.79 s | 8.34 s | 8.09 s | 8.13 s |

The sum of the critical current of each wire is 402.1 A and whole critical current is 399 A. Difference between these two values is 3.1 A. Current of HTS₂ is exceeded the critical current at 7.79 s firstly, and that of HTS3 is exceeded at 8.34 s lastly. The current of whole coil is exceeded the critical current at 8.13 s. It shows that, though transport current of one or more paths of coil is/are not exceeded the critical current, resistance of the whole coil could be reach the same as a criterion of critical current. Current increasing ratio of I₃ begins to arise after about 7.8 s. It is because that current of HTS₂ still does not exceed the critical current. The ratio of transport current of copper increases according to the excess of each HTS path. Because the critical current of I₄ is the smallest as shown in Table IV, though it is exceeded the critical current at 8.09 s, its increasing ratio of is not raised as that of HTS₃ does. The ratio of the final current of each path changes, which signifies that the resistance generated in HTS wire by transport current is changed after the excess of critical current. The largest current flows into HTS₁. This is the case that quench begins, as shown FIG. 11., it can be understood that the current of copper layer begins to increase.

Parameters for the simulation of non-insulated and multi-stacked HTS Solenoid coil are shown in Table II and III. Other conditions are the same as those of insulated and multi-stacked HTS solenoid coil. As shown in FIG. 13, the simulated result coincides well with the experimental result. Percentages of the final current of I_{cu}, I₁, I₂, I₃ and I₄ are 0.31, 25.84, 25.02, 24.55, 24.28% respectively. Because the small-scale solenoid coil has 5 copper bars to settle current probes and its inductance is small, each path has a different resistance. Transport current is inversely proportional to the resistance of each path.

FIG. 14 shows two experimental results of current sharing in the HTS coil with a ramping rate of 500 A/s and final current of 700 A. These results show different current sharing phenomenon. As shown in the left graph of FIG. 14, the transport current of each path is changed after 1.9 s although current increase is finished. I₄ is increased and that of I_{cu}, I₁, I₃ is decreased rapidly. The ratio of each transport current value of right graph in FIG. 14 is not changed throughout the repeated experiments. It shows that the stainless steel soldered on each side of HTS wire acts as an insulator. But it is not insulator anymore after quench.

About 10% of the whole current goes into the copper layer in this experiment. This shows that the copper layer can be a good current path when HTS coil is fully quenched.

As described above, current distribution ratio of the large HTS coil can be estimated on the basis of the correspondence between the result of simulation of current distribution in multi-layer HTS coil and experimental results. In a large HTS coil, a copper layer serves as an excellent current path when HTS coil is fully quenched.

A bobbin having a supplementary winding of coil according to the present invention has advantages in that problems caused due to generation of heat resulted from a concentration of current at a single point of a superconducting coil can be prevented since the supplementary winding of coil bears the current of early stage of fault current. In addition, since these advantages are accomplished even without transposing the superconducting coil, necessity of insulation between windings is eliminated and difficulty in winding manner is avoided.

The invention has been described in great detail in the foregoing specification, and it is believed that various alterations and modifications of the invention will become apparent to those skilled in the art from a reading and understanding of the specification. It is intended that all such alterations and modifications are included in the invention, insofar as they come within the scope of the appended claims.

1. A DC reactor with a bobbin for a current limiting device for limiting fault current of an electric power system, said DC reactor comprising a supplementary winding of conducting coil for uniformly distributing said fault current to each winding of superconducting coil stacked on the bobbin.

2. A DC reactor according to claim 1, wherein said supplementary winding of conducting coil is arranged at the outermost part of said bobbin.

3. A DC reactor according to claim 1, wherein said supplementary winding of conducting coil is made up of a copper.

4. A DC reactor according to claim 1, wherein said superconducting coil is stacked together with said conducting coil.

5. A DC reactor according to claim 1, wherein said stacked superconducting coil is transposed only in joints.
